(19) United States
(12) Patent Application Publication
(10) Pub. No.: US 2003/0074830 A1
(43) Pub. Date: Apr. 24, 2003

(54) Luminescent jig component, jig, and method of manufacture and use thereof

(76) Inventor: Charles David Goeke, Hightstown, NJ (US)

Correspondence Address: GORDON-LENDVAY PATENT AGENCY, P O BOX 101, WHITE PLAINS, NY, 10605

(21) Appl. No.: 10/314,644

(22) Filed: Dec. 9, 2002

Related U.S. Application Data
(63) Continuation-in-part of application No. 09/932,022, filed on Aug. 17, 2001, now Pat. No. 6,416,354.

(51) Int. Cl. A01K 85/00

(52) U.S. Cl. 43/42.39

(57) ABSTRACT

A fishing jig body capable of housing a chemiluminescent cartridge includes a channel in a lateral side of the jig body which allows the cartridge to pressed into a central chamber but is shorter than the cartridge such that the process causes the cartridge to flex and activate the luminescent material within. The jig body is made of a specific size and weight so that it will sink into deep water against currents to a empirically determined depth without the need for adding additional weight to the line or tackle attached to the jig body. Optionally, the jig body may have provision for attaching additional weight without significantly altering the overall shape or appearance of the jig body. Optionally, additional channels may be disposed in the jig body to allow light to escape from the chemiluminescent cartridge through other points on the jig body thereby highlighting features of the body, outlining it, or creating the appearance of appendages or fins. Provisions are also optionally provided for allowing multiple bodies to be linked together or multiple hooks to be attached.

### FIELD OF THE INVENTION

This applications relates to inventions which deal with the catching of fish, especially food fish. More specifically this invention relates to apparatus and methods for hooking or gathering fish. Even more specifically this invention relates to apparatus having means to illuminate the apparatus or to give off light rays, specifically including devices in the form of an artificial bait or lure wherein the light source is in or on the lure.

### BACKGROUND

Fishing being an age old practice includes a multitude of methods for obtaining fish including numerous devices and equipment. The equipment surrounding each method is specifically designed and fine tuned to produce the most efficacious result for that particular method. Even sport fishing has developed a multiplicity of specialties, each with their own enthusiastic followers and proponents. The particular invention that is the subject of this patent, is specifically directed toward the specialty of jig fishing. So named because the fisherman repeatedly lifts the line up out of the water then lowers it quickly so that the device at the end of the line (called a jig) returns back to its original place at its own natural pace and pathway. This up and down movement is called jigging with the result being that the fish-attracting-device, at the end of the line, swirls and dances each time it falls back through the water.

Jig fishing, most used for fishing in very deep water, is usually a salt water technique, although some larger fresh water bodies of water are suitable for jigging. The fish attractors, called jigs are intended to lure the quarry by mimicking natural prey. They are usually brightly colored, reflective, and mottled or faceted. In shallower clear waters, such as within 50 feet of the surface, and during the day the reflective surface picks up the sunlight gives the impression of being a reflective scaly object. However, in deep waters beyond sunlight penetration, or at night, the reflective finish of most jigs is of little advantage.

In the natural deepwater environment, there is no light and food is scarce. Predatory creatures often have the capability of chemically producing illumination, thought to be advantageous not only as a means of detecting the presence of prey, but, when activated suddenly, as a mechanism of startling the prey long enough to make capture more likely. However, this chemilumination is also a liability; because many even larger predators are capable of detecting the light and have become used to finding dinner at the source. Ironically, even the predators of the predators becomes prey, because fisherman have learned that fish are attracted to light. The result being that they have made attempts to “catch more fish” by incorporating light generating devices into their fishing techniques.

The field of artificial bait is rich in lures and other riggings with luminary means to attract the quarry. Most of these however are not functional when using the jigging technique. These range from non-jig-type tackle such as topwater lures and crankbait with luminary features incorporated; to luminary devices attached to the fishing line that leads to a lure or jig, and/or illumination devices and techniques expended into the vicinity of the fishing activity. For example,

Sylla, U.S. Pat. No. 6,108,960, the entirety of which is incorporated herein by reference, utilizes a spring-type mechanism for holding a chemiluminescent light source in the body of a type of fishing lure known as a crankbait. Crankbait is a low density material that floats and incorporates a bill that causes the bait to dive when it is pulled through the water that cannot be used for jigging even with the addition of weights. The chemiluminescent effect in the Sylla device is a capsule placed in the belly of the crankbait which is an unnatural position for luminescence and is more exposed to damage when the lure contacts the bottom that could cause the contents to spill or leak into the environment. All crankbait lures such as the devices of Ottaviano, U.S. Pat. No. 4,709,499 or Steinman, U.S. Pat. No. 4,610,103, each the entirety of which is incorporated herein by reference share most of the same features making them un-usable as jig fishing tackle.

Robert N. Mattison's invention, U.S. Pat. No. 4,777,756 the entirety of which is incorporated herein by reference, is a multi-piece jig that requires assembly, addition of weight, and requires the fishing line to be threaded through a Teflon tube. This tube can become misshapen or distorted at the time the line is cast into the water; tangling lines or fouling the tube with sand and preventing the intended mobility of the jig. If a fish is caught, the light, the jig and/or weight need to be removed then the fishing line rethreaded through the tube (ordinarily troublesome but extremely difficult when fishing on a dark night) and the jig and/or weight retied.

### OBJECTS AND SUMMARY OF THE INVENTION

It is an object of the present invention to provide a jig body that overcomes the drawbacks or disadvantages of the prior art. It is another object of the present invention to provide A jig body for constructing a deep water fishing jig, including: a body having a lead core, the body also having at least one coating layer; central chamber(s) for holding a luminescent cartridge; elongated channel(s) for passing the luminescent cartridge to and from the central chamber; the body also having attachment eyes for attaching to a line, or a line attachment rigging, and a hook, or a hook attachment rigging to the body; the body having a hammered or a smooth surface; the body having planer axes with an asymmetry, a bilateral symmetry, and/or a multilateral symmetry; and the symmetry imparting a nonlinear, a linear, an oscillating, or a swooshing movement to a deep water fishing jig constructed using the jig body when the deep water fishing jig is freely sinking in water; and the symmetry also imparting a non-linear, a linear, an oscillating, and a swooshing movement to a deep water fishing jig constructed using the jig body when the deep water fishing jig is being pulled through water by a fishing line.

In this regard, one feature of the jig body of the present invention provides that the elongated channel is dimensioned to allow passing the luminescent cartridge to and from the central chamber only under the limited condition that the luminescent cartridge is in a state of flexion. Another optional feature of the jig body of the present invention provides that the coating layer is of a material classifiable as a metal, a plastic, a rubber, an enamel, an ink, or a glass. Another optional feature is that the central chamber for holding the luminescent cartridge could be capable of holding multiple the luminescent cartridges. Yet another optional feature is that one or both the attachment eyes is a hole in the body, or a solid loop of wire.

It is another optional feature of the present invention to provide that the first attachment eye and/or the second attachment eye is:

a hole in the body; a molded hole in the body reinforced with a reinforcement; and/or

an embedded wire, the wire having a loop portion extending from within the core of the body;

Another goal is to provide optional jig body main body shapes with:

the main body shape being longitudinally curvilinearly elongated and cross-sectionally diamond shaped with the symmetry being bilateral across all planer axes, and two elongated channels are elongated longitudinally and traverse laterally;

the main body shape being disc shaped overall with a longitudinal curvilinear tendency, a cross-sectional vertically curvilinear elongation, and a laterally viewed circular or oval shape, with the symmetry being bilateral across all planer axes, and two elongated channels are elongated longitudinally and traverse laterally;

the main body shape being vertically disc shaped overall with a longitudinal curvilinear tendency, a cross-sectional vertically curvilinear elongation, and a laterally viewed circular or oval shape, with the symmetry being bilateral across vertical and horizontal top and bottom view planer axes, and across vertical lateral and end view planer axes but not across horizontal lateral and end view planer axes, and two elongated channels are elongated longitudinally and traverse laterally;

the main body shape being horizontally disc shaped overall with a longitudinal curvilinear tendency, a cross-sectional horizontally curvilinear elongation, and a laterally viewed flattened oval shape, with the symmetry being bilateral across vertical and horizontal top and bottom view planer axes, and across vertical lateral and end view planer axes but not across horizontal lateral and end view planer axes, and two elongated channels are elongated longitudinally and traverse laterally; or,

the main body shape being vertically egg shaped overall with an upward orientation, with the symmetry being multilateral across vertical and horizontal top and bottom view planer axes, and bilateral across vertical lateral and end view planer axes but not across horizontal lateral and end view planer axes, and all the elongated channels are elongated vertically and traverse radially, and the central chamber is elongated in a vertical orientation.

In other words, the main body shape is the shape of a fish body, the shape of a flounder body, the shape of a ray body, the shape of a squid body, the shape of a crab body, the shape of a lobster body, the shape of a octopus body, the shape of an eel body, the shape of a worm body, the shape of a snake body, the shape of a crustation body, or the shape of an invertebrate body.

If the jig body is vertically egg shaped overall with the symmetry being multilateral across vertical and horizontal top and bottom view planer axes, it could also include the first attachment eye disposed centrally on the dorsal surface; and a second attachment eye for each elongated channel disposed on a dorsal radial edge.

Another feature of the present invention is that it can include one or more attachable weight cassettes, each the attachable weight cassette having a shape complementary to a receiving surface on the jig body; each attachable weight cassette combinable with an additional attachable weight cassette; and each attachable weight cassette attachable to and removable from the jig body even when an additional attachable weight cassette is already attached to the jig body.

Another embodiment is anticipated wherein: a jig body has a main body shape, the main body shape is the shape of a fish body, the shape of a flounder body, the shape of a ray body, the shape of a squid body, the shape of a crab body, the shape of a lobster body, the shape of a octopus body, the shape of an eel body, the shape of a worm body, the shape of a snake body, the shape of an amphibian body, the shape of a crustation body, the shape of a vertebrate body or the shape of an invertebrate body; the jig body encases an elongated central chamber, the elongated central chamber size to removably constrain a chemiluminescent cartridge therewithin; also the elongated channel communicates lateral external exterior surface(s) with the chemiluminescent cartridge, and a total number of attachment eyes is one less than one attachment eye for each elongated channel through which the chemiluminescent cartridge can be inserted to and removed from the elongated central chamber.

The present invention also anticipates a jig made from the jig body.

The present invention also anticipates a method of manufacturing the jig body, including the steps of molding the lead core of the jig body in a mold designed to produce the lead core in a size and weight appropriate for jigging at a specified depth and current; and coating the lead core to form the coating layer.

Furthermore the invention may also include a method of manufacturing the jig body wherein the step of molding the lead core of the jig body in a mold further includes the steps of: inserting a plug in a mold, the inserted plug having a shape imposed into a cavity of the mold that is the solid combined equivalent of the central chamber and the elongated channel inserting first and second attachment eye forming means; assembling the mold; and introducing a molten lead metal into the cavity.

The invention also includes a method of using the jig body including the steps of: making a jig; and pressing an activatable chemiluminescence cartridge into the central chamber through one of the at least one elongated channels thereby causing the activatable chemiluminescence cartridge to flex and activate.

The jig body may further include additional light emitting channel leading from the central chamber to a lateral surface, a dorsal surface, a ventral surface, a leading end surface and/or a trailing end surface.

In summary, the present invention is directed to a fishing jig body capable of housing a chemiluminescent cartridge includes a channel in a lateral side of the jig body which allows the cartridge to pressed into a central chamber but is shorter than the cartridge such that the process causes the cartridge to flex and activate the luminescent material within. The jig body is made of a specific size and weight so that it will sink into deep water against currents to a empirically determined depth without the need for adding additional weight to the line or tackle attached to the jig body. Optionally, the jig body may have provision for attaching additional weight without significantly altering the overall shape or appearance of the jig body. Optionally, additional channels may be disposed in the jig body to allow light to escape from the chemiluminescent cartridge through other points on the jig body thereby highlighting features of the body, outlining it, or creating the appearance of appendages or fins. Provisions are also optionally provided for allowing multiple bodies to be linked together or multiple hooks to be attached.

The above, and other objects, features and advantages of the present invention will become apparent from the following description read in conjunction with the accompanying drawings, in which like reference numerals designate the same elements.

### BRIEF DESCRIPTION OF THE DRAWINGS

FIG. 1a. Is a perspective view illustration of an embodiment of the present invention.

FIG. 1b. Is a top view illustration of the FIG. 1a embodiment of the present invention.

FIG. 1c. Is an end view illustration of the FIG. 1a embodiment of the present invention.

FIG. 1d. Is a lateral (side)view illustration of the FIG. 1a embodiment of the present invention.

FIG. 2. Is a top view illustration of a jig of the present invention.

FIG. 2a. Is an illustration of how a chemiluminescent cartridge fits into the FIG. 2 embodiment of the present invention.

FIG. 2b. Is an end view illustration of the FIG. 2 embodiment of the present invention.

FIG. 2c. Is anther end view illustration of the FIG. 2 embodiment of the present invention.

FIG. 3. Is a 4 step illustration for tying a Palomer Knot

FIG. 4. Illustrates another embodiment of the present invention having a more disk like shape that is asymmetrical in at least one axis.

FIG. 5a. illustrates a reinforced attachment eye that has been molded into the head or tail of jig body of the present invention.

FIG. 5b. illustrates another attachment eye, of the present invention with additional features molded into the jig body of the present invention.

FIG. 5c. further illustrates another embodiment of a jig body of the present invention also including additional features molded therein.

FIG. 6a. illustrates an embodiment of the present invention having an alternative channel configuration.

FIG. 6b. illustrates vertically directed radiating channels that communicates with a circumferential groove.

FIG. 6c. illustrates the linking of several metallic jig bodies together.

FIG. 6d. illustrates an elongated metallic jig body capable of holding multiple cartridges placed end to end within a lengthwise elongated central chamber.

FIG. 6e. illustrates a metallic jig body having a globular egg-like shape.

FIG. 7a. demonstrates increasing the size of metallic jig body as a means of selecting the desired jig weight.

FIG. 7b. demonstrates a pluggable channel in metallic jig body which can be partially or fully filled with lead shot.

FIG. 8. Illustrates the features of a mold for manufacturing an embodiment of the present invention.

### DETAILED DESCRIPTION OF THE PREFERRED EMBODIMENT(S)

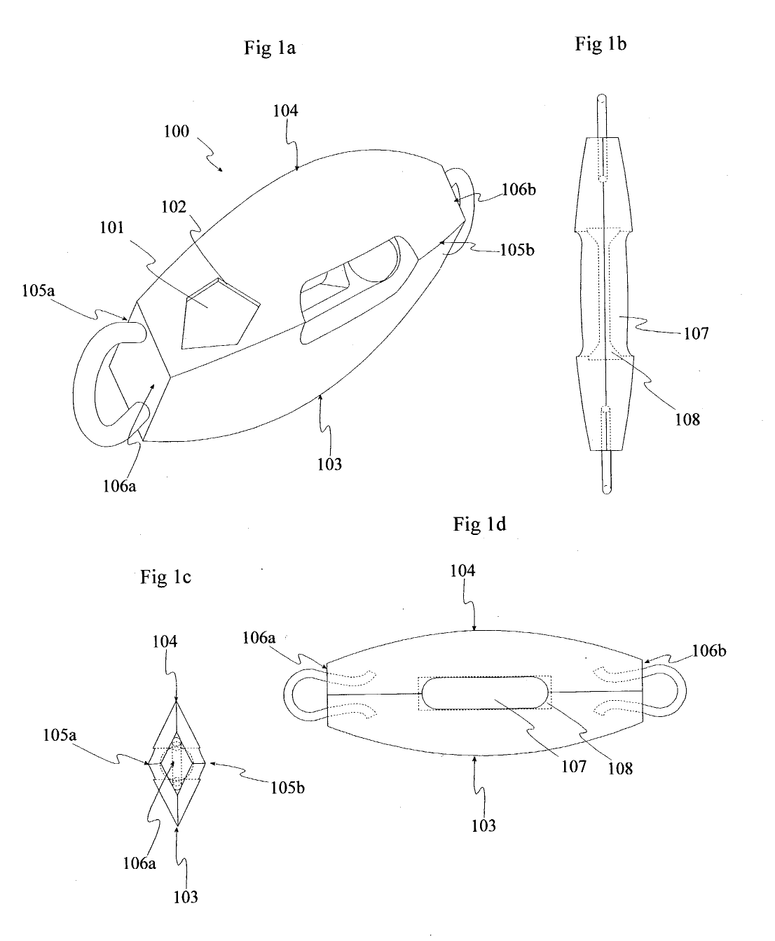

In a first embodiment, referring to FIGS. 1a-d, a metallic jig body 100 has a core 101 of lead or lead alloy, and at least one coating layer 102. Metallic jig body 100 is bilaterally symmetrical across all planer axes and can be oriented such as in the figures to have a ventral (bottom) side 103, a dorsal (top) side 104, first and second lateral sides 105a and b and first and second ends 106a and b. A laterally elongated channel 107 passes through metallic jig body 100 so as to enable communication from either lateral side 105 to a central chamber 108; central chamber 108 having a shape that is essentially tubular with blind ends.

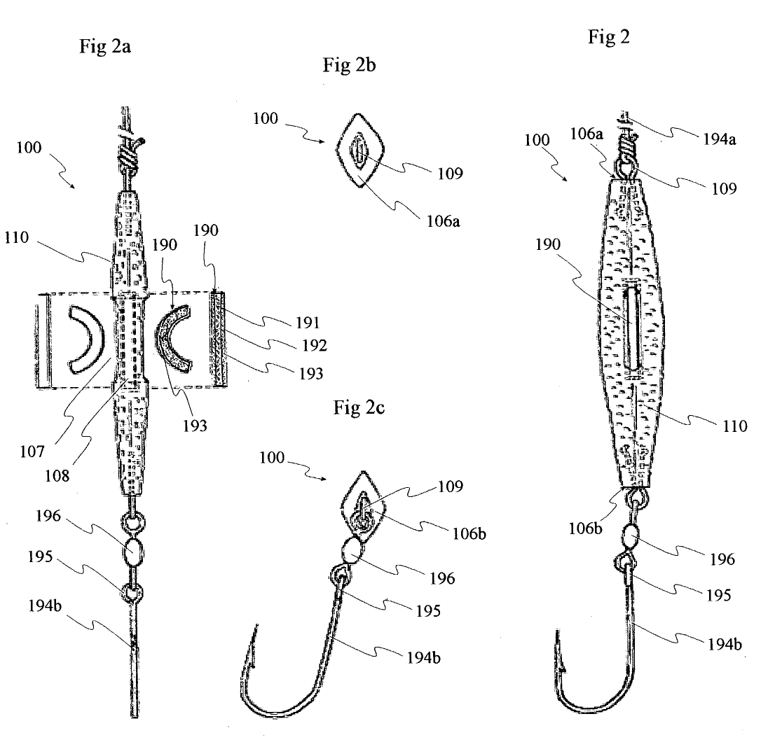

A sealed tubular cartridge 190, made of a resilient translucent or transparent material and containing an activatable luminescent material has a standard size and central chamber 108 is sized (both radially and lengthwise) to house sealed tubular cartridge 190 (See FIG. 2). Channel 107 is less elongated than central chamber 108 is long, the difference being enough to secure sealed tubular cartridge 190 within central chamber 108 but not so much as to prevent a flexed sealed tubular cartridge 190′ from being inserted into central chamber 108, therethrough.

Metallic jig body 100 has at least one attachment eye 109 at each end 106. Additional, attachment eyes may be optionally disposed elsewhere. Each attachment eye is made of a material that has not only sufficient tensile strength to withstand the force exerted thereon when a fish strikes the hook and throughout the subsequent procedure whereby the fish is ultimately extracted from the water, but also to withstand the pummeling forces of particulate laden deep water currents. The intent of placing attachment eyes 109 on metallic jig body is to allow the jig fisherman to attach tackle components such as hooks, leaders, swivels, etc., thereto; and to create the appearance of prey.

Metallic jig body 100 has a surface texture 110 being smooth, rough, mottled, dented, faceted, etc. or a combination thereof Surface texture 110 likewise impressionistically imitates the surface appearance of prey. Surface texture may be inherent in either core 101 or coating 102. If coating 102 is relatively thin such as the case when it is a metallic electroplated surface coating of chromium and nickel then the texture of core 101 would dramatically influence the final texture. However a thick coating such as an enamel or vulcanized surface would likely obscure any core 101 influence.

Referring to FIG. 2a, in the context of FIG. 2, sealed tubular cartridge 190 contains a luminescent material 191 and an activator 192. Activator 192 is sequestered from luminescent material 191 by a membrane 193 such that when sealed tubular cartridge 190 is flexed, membrane 193 ruptures releasing activator 192 to mix with and activate luminescent material 191. Once activated luminescent material 191 emits soft light at a wavelength characteristic of the particular chemical luminescent system.

To use a jig constructed with metallic jig body 100, sealed tubular cartridge 190 needs to be activated and inserted into central chamber 108. The process of so inserting obligates the fisherman to flex sealed tubular cartridge 190 in order to traverse channel 107 and seat both ends into central chamber 108. This guarantees that membrane 193 will be ruptured at the time the jig is being rigged. In this regard the fisherman cannot forgets to activate the system prior to casting the jig into the water.

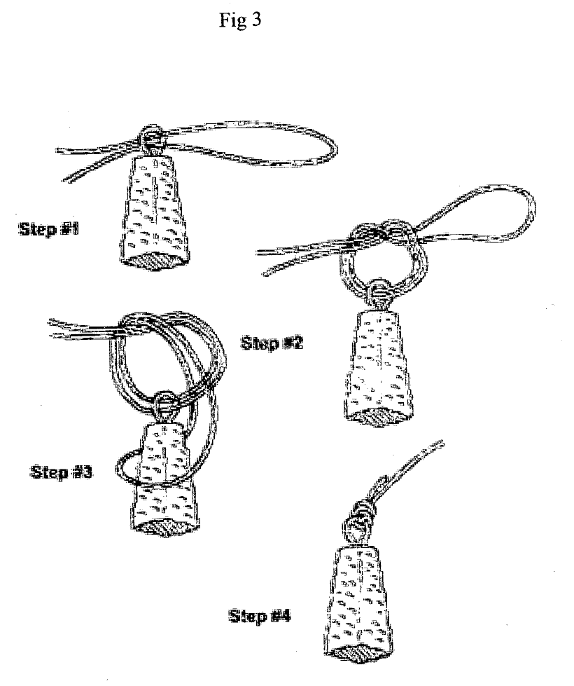

Referring to FIG. 2b, in the context of FIG. 2, a fishing line 194a is attached to metallic jig body 100 by one of the attachment eyes 109 at first end 106a. This is usually accomplished by common knotting techniques, known to fishermen, utilizing a strong knot such as a Palomar knot. The closed configuration of attachment eye 109 in conjunction with the compact size and shape of metallic jig body 100 lends itself to easily tying these simple knots. FIG. 3 shows a four step sequence for tying a Palomar knot. Referring to FIG. 2c, in the context of FIG. 2, the story is somewhat different at second end 106b in that a fishing hook 194b is to be attached here. Since fishing hooks are also usually made with closed loop eyes 195 for attaching, other means for interconnecting closed loop eye 195 with attachment eye 109 at second end 106b. This is accomplished here by the use of an interconnecting swivel 196 such as a brass barrel or ROSCO type swivel.

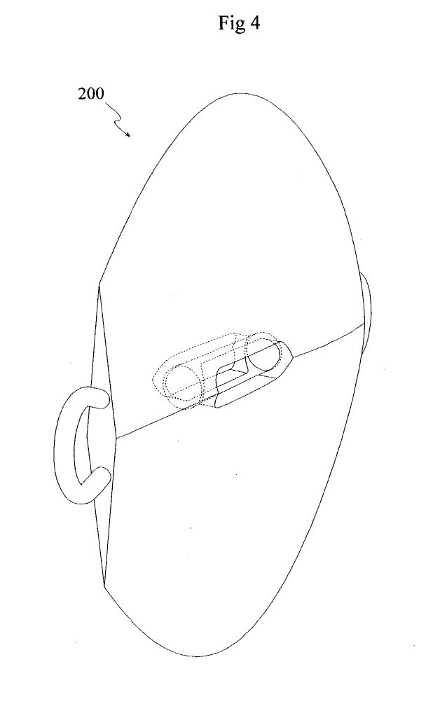

Referring to FIG. 4, another embodiment of the present invention utilizes a metallic jig body 200 having a more disk like shape that is asymmetrical in at least one axis. FIG. 4 illustrates another of the myriad of shapes anticipated that mimic the shape, appearance or movement of prey. Here, jig body 200 is weighted “head forward” so as to favor a head down movement during the down jig stroke that follows the inherent head up movement of the up stroke. This movement is postulated to mimic that of a ting prey struggling to escape a strong current that has swept it into deep water.

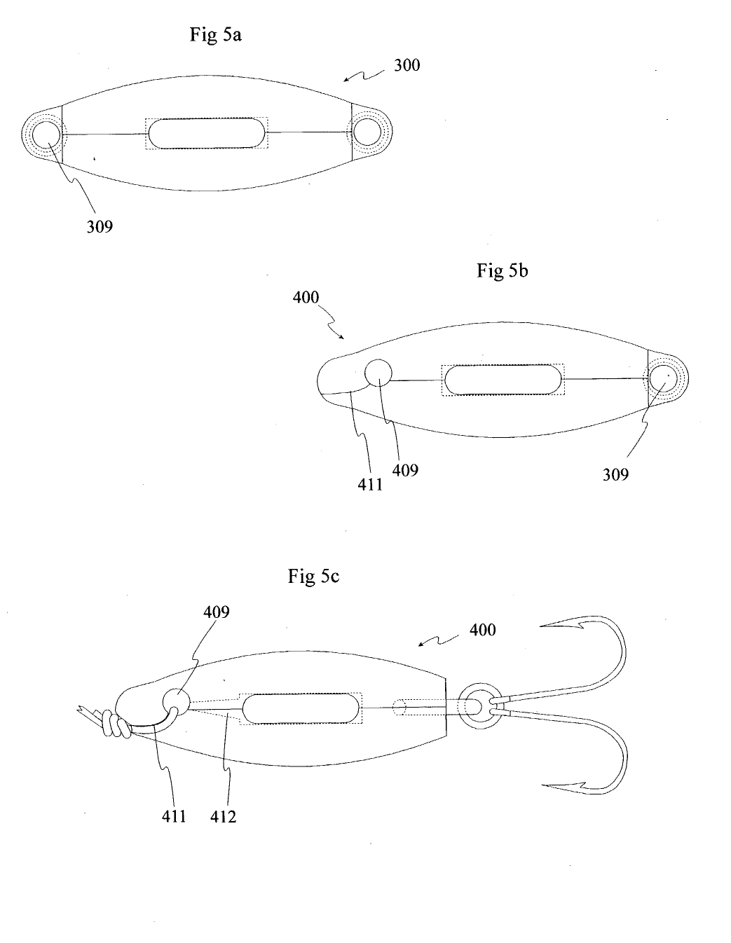

Referring to FIGS. 5a-c, additional embodiments of the present invention illustrate the use of alternative attachment means for offering flexible configuration of the final jig. FIG. 5a illustrates reinforced attachment eye 309 that has been molded into the head or tail of jig body 300. FIG. 5b illustrates attachment eye 409 also molded into jig body 400 but including additional structure to guide the knot into a pocket slot 411 that resembles the appearance and position of a mouth line and having attachment eye 409 located at the position expected for location of an eye. FIG. 5c further illustrates jig body 400 also including at least one small channel 412 communicating central chamber 408 with attachment eye 409.

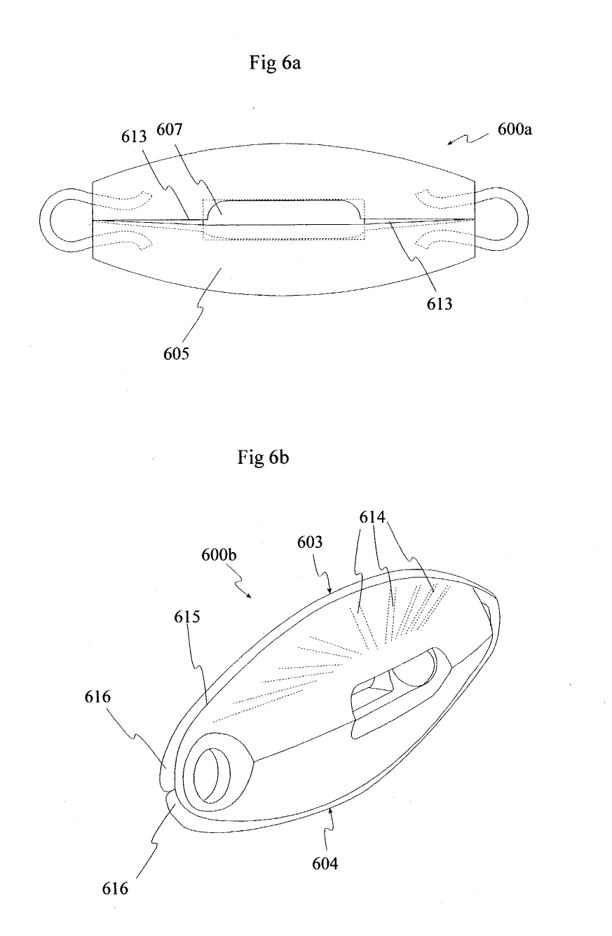

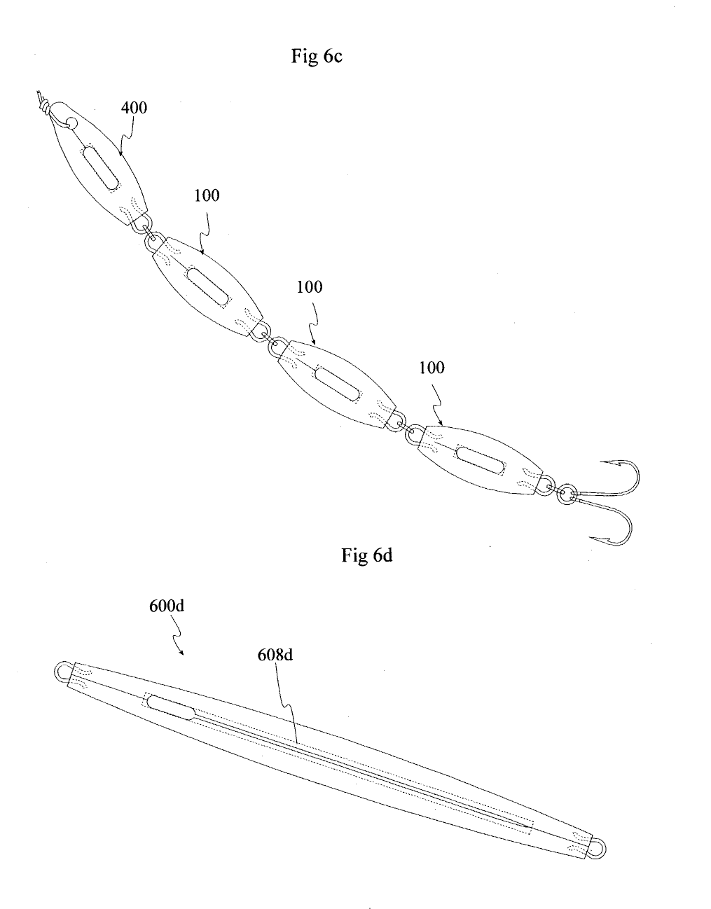

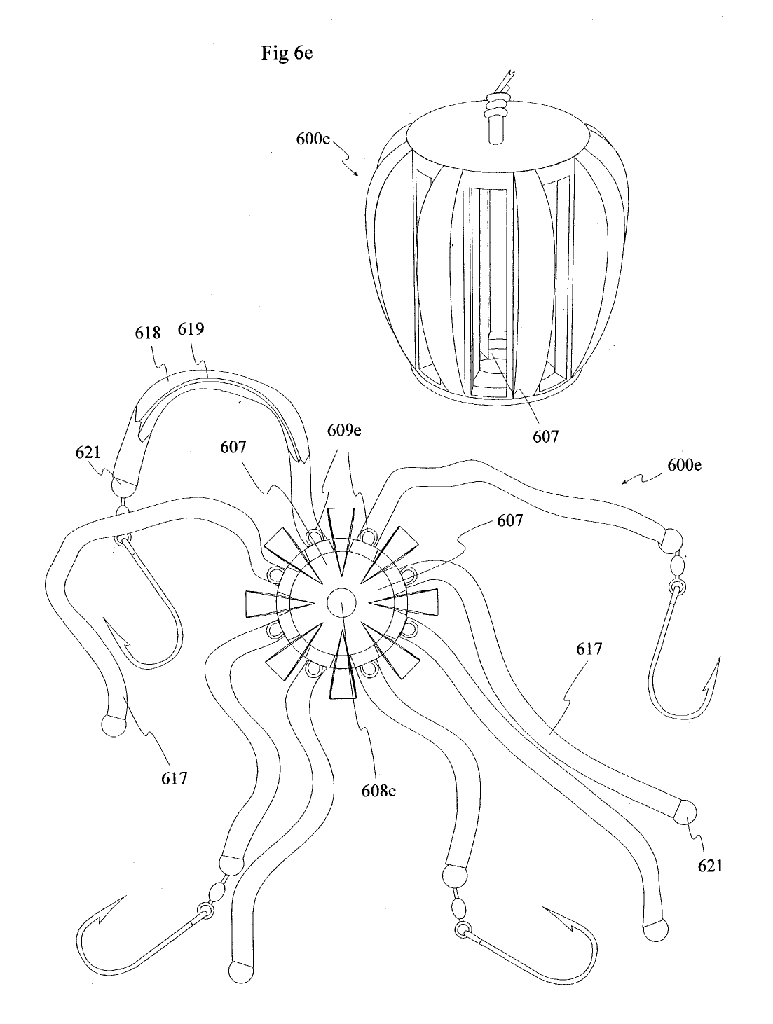

Referring next to FIGS. 6a-g, further embodiments illustrate adaptations to the illumination features of the jigs of the present invention. In FIG. 6a, channel 607 is disposed at an acute angle to lateral side 605 and has additional endwardly directed longitudinal groove-like extensions 613 along lateral sides 605. Groove like extensions 613 allow the luminescent light from tubular cartridge 190 to emanate from central chamber 608a along a line the entire length of metallic jig body 600a with diminishing intensity toward the ends and highest intensity at the center. The effect is to highlight the lateral line of a small fish.

FIG. 6b illustrates a vertically directed radiating channels 614 that communicates a circumferential groove 615 along the dorsal and ventral sides 604 and 603 of metallic jig body 600b with central chamber 608b. (Only dorsally directed radiating channels 614 are shown) A loop of monofilament fishing line 616 is places in circumferential groove 615 to homogenize the light intensity. The lighted monofilament line outlines the shape of metallic jig body 600b.

FIG. 6c illustrates the linking of several metallic jig bodies together here several metallic jig bodies 100 are linked to a metallic jig body 400 giving a segmented eel like appearance with an internal movement segment. FIG. 6d illustrates an elongated metallic jig body 600d having an elongated central chamber 608d capable of holding multiple cartridges 190 placed end to end therewithin.

FIG. 6e illustrates a metallic jig body 600e having a globular pear-like shape with multiple channels 607 communicating with central chamber 608e. An attachment eye 609e is disposed at a terminus of each channel 607. Tentacle like extensions 617 of an opaque semi-flexible tubing 618 are threaded with a least one loop of line 619 and held in place against jig body 600e over attachment eye 609e by the tension of loop of line 619. Placement of tentacle like extensions 617 within channels 607 allows light to reflect off their surface highlighting their appearance. Optionally, attachment eye 609e extends from a short post having a diameter that is consistent with a tight fit within the internal diameter of semi-flexible tubing 618.

Tension of loop of line 619 is created by stretching against its inherent resilience when tying to or through a termination body 621 at the jig body distal end of semi-flexible tubing 618. Tentacle like extensions 617 terminate with a tackle component such as weight, a hook, a bead or a combination thereof. The thickness and semi-flexible nature of the tentacle like extensions 617 due to semi-flexible tubing 618 keeps them from becoming tangled in the water. Terminating tentacle like extensions 617 with different tackle components causes each to have a unique jigging action. Limiting the number of hooks, placing hooks toward the jig body proximal end of tentacle like extensions 617, or optionally, only attaching hooks directly to metallic jig body 600e, keeps tentacle like extensions 617 from becoming entangled.

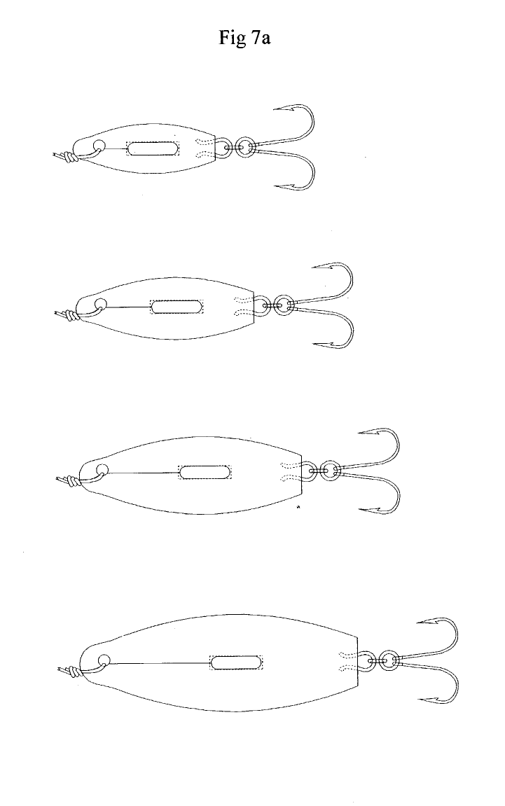

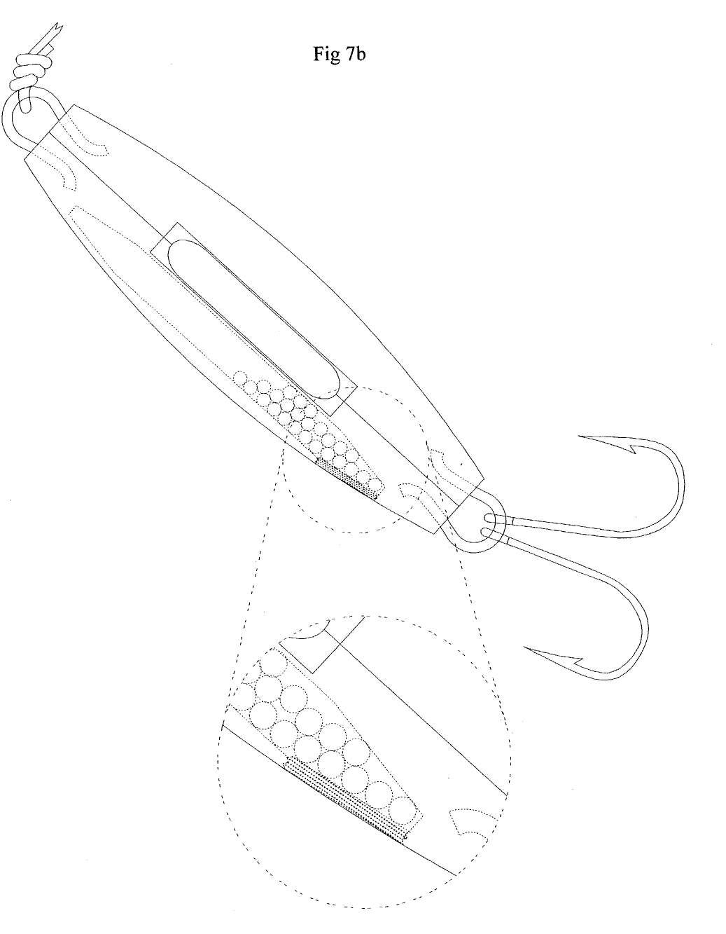

Referring to FIGS. 7a & 7b, embodiments allowing the fisherman to adjust the weight of the jig are illustrated to allow the jig to be placed at a depth well within the margins of a deep water current. FIG. 7a demonstrates finer weight control by the use of increasing size of metallic jig body 100 as a means of selecting the desired jig weight. While FIG. 7b demonstrates the presence of a pluggable channel in metallic jig body 700b which can be partially or fully filled with lead shot. It is also expected that one or more jig body attachments could be attached added to the dorsal or ventral sides of metallic jig body 100 as a means of adding or removing weight therefrom until the desired jig weight is achieved. This could be accomplished by attachment of moon shaped pieces of the same length as metallic jig body 100 via attachment eyes 109 or via the presence of a dovetail- or T-channel 623 in a metallic jig body 700c which can be partially or fully filled by sliding moon shaped lead pieces 624 serially within.

Method of Manufacture

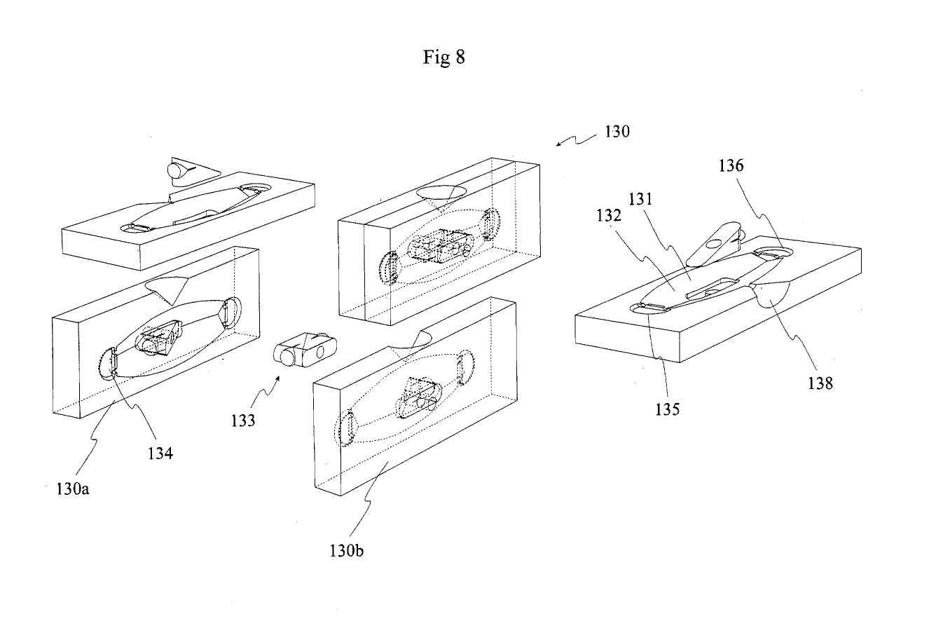

Referring to FIG. 8, hand manufacturing is possible using a two-piece mold 130 of mirrored halves 130a & 130b. Mold 130, made of stainless steel, cast iron or aluminum, must be able to withstand temperatures in excess of 750 degrees Fahrenheit for long periods of time. Mold 130 has an elongated cavity 131 with a hammered or smooth interior finish 132, depending on the type jig being made. Molds 130 to produce varying weights and lengths are marked accordingly. A plug 133, inserted at the time of casting, will produce a centered cavity completely through the body of the jig. This cavity is designed for the sole purpose of inserting and holding chemiluminescent cartridge 190.

Mold 130 displays a machined hole 134 at each of first and second ends 135 and 136. This hole will accept a stainless steel or brass eyelet wire 137, inserted at the time of casting. The purpose of the eyelets in the above illustrated embodiments are attachment to a fishing line connected to a retrieving device such as a fishing rod, and attachment of a brass barrel or ROSCO type swivel with the intent of attaching to a fishhook. A sprue 138 in mold 130 is placed appropriately.

The casting materials being, for example, remanufactured lead, tin and antimony (antimony giving the strength needed to maintain the integrity of the body at the cavity site), are melted to a working temperature of 750 degrees Fahrenheit and poured into selected molds 130. Once cooled, mold 130 is opened, plug 133 is removed, the produced diamond shaped jig body core 101 extracted from the mold and cleaned, a barrel or ROSCO swivel 196 is then attached, and the total entity is electroplated with a coating metal 102 such as copper, nickel, chromium (chrome) or a combination thereof The electroplating process may include the use of multiple electroplating steps with the use of resistive paints prior to each step to selectively pattern metallic jig body 100.

The manufacture of a first embodiment is described above using a hand method. However, use of faster methodologies and automation of manufacturing is also anticipated and well within the scope of skill in the art of casting and manufacture, to extend and adapt the above manufacturing description to other embodiments using other methodologies.

Use of the Jig

The smaller sizes are most commonly used when fishing for blue fish and striped bass, the larger sizes for tuna, cod and shark. The use of this jig is simple. One must first tie a fishing line, using a strong knot such as a Palomar knot (FIG. 3), through the attachment eye 109. Next attach the desired sized hook 194, if not previously installed, to the swivel 196 at the second end. Prepare the chemiluminescent cartridge 190 by holding the ends of thereof between the thumb and index fingers of each hand and flexing the cartridge 190 until a faint snap is heard. This snap is the rupture of internal capsule membrane 193 allowing the mixture of activator 191 with luminescent material 192 within cartridge 190 thus creating a warm glow of light.

The expected life of activated luminescent material 192 is four to six hours. While cartridge 190 is flexed, one can then insert it through channel 107 into central chamber 108 and straighten cartridge 190 by sliding a finger along the length thereby seating it into the center of metallic jig body 100.

Once the jig is cast into the water, using an up and down movement of the rod will help the light capsule and bright chrome finish of the jig entice fish to strike. Upon strike; set the hook and reel in the catch. When finished fishing, remove the capsule and dispose in the trash not in the ocean. The jig is ready for the next fishing trip.

Although this design was initially intended for night and deep—dark water fishing, it can be utilized in clear waters and during daylight hours. This one type jig eliminates the need for additional jigs. Note also that unlike the adaptation of lures, reflector spoons, and other tackle containing chemiluminescent qualities, by combining them and adding lead weights thereto, the jig of the present invention is a single piece not only possessing simultaneously all the functions of a lure, spoon, lead weight, and chemiluminescent capsule holder but additionally is optimized by its shape and size to return the best jigging response in the face of the rigors of fishing a deep water current.

Having described a range of preferred embodiments of the invention with reference to the accompanying drawings, it is to be understood that the invention is not limited to those precise embodiments, and that various changes and modifications may be effected therein by one skilled in the art without departing from the scope or spirit of the invention as defined in the appended claims.

What is claimed is:

1. A jig body for constructing a deep water fishing jig comprising:
a body having a lead core, said body having at least one coating layer;
at least one central chamber for holding at least one luminescent cartridge;
at least one elongated channel for passing said at least one luminescent cartridge to and from said central chamber;
said body having at least one first attachment eye for attaching to one of a line and a line attachment rigging;
said body having at least one second attachment eye for attaching at least one of a hook and a hook attachment rigging to said body;
said body having at least one of a hammered and a smooth surface;
said body having at least one planer axis with at least one of an asymmetry, a bilateral symmetry, and a multilateral symmetry; and
said symmetry across said at least one planer axis imparting at least one of a non-linear, a linear, an oscillating, and a swooshing movement to a deep water fishing jig constructed using said jig body when said deep water fishing jig is freely sinking in water; and
said symmetry across said at least one planer axis also imparting at least one of a non-linear, a linear, an oscillating, and a swooshing movement to a deep water fishing jig constructed using said jig body when said deep water fishing jig is being pulled through water by a fishing line.

2. The jig body of claim 1, wherein said at least one elongated channel is dimensioned to allow passing said luminescent cartridge to and from said central chamber only under the limited condition that said luminescent cartridge is in a state of flexion.

3. The jig body of claim 1, wherein said at least one coating layer is of a material selected from the group consisting of a metal a plastic, a rubber, an enamel, an ink, and a glass.

4. The jig body of claim 1, wherein said at least one central chamber for holding at least one luminescent cartridge is capable of holding multiple said luminescent cartridges.

5. The jig body of claim 1, wherein at least one of said first attachment eye and said second attachment eye is one of, a hole in said body and a solid loop of wire.

6. The jig body of claim 1, further comprising:
Said jig body having a main body shape;
Said jig body selected from the group consisting of:
said main body shape being longitudinally curvilinearly elongated and cross-sectionally diamond shaped with said symmetry being bilateral across all planer axes, and two said at least one elongated channels are elongated longitudinally and traverse laterally;
said main body shape being disc shaped overall with a longitudinal curvilinear tendency, a cross-sectional vertically curvilinear elongation, and a laterally viewed circular or oval shape, with said symmetry being bilateral across all planer axes, and two said at least one elongated channels are elongated longitudinally and traverse laterally;
said main body shape being vertically disc shaped overall with a longitudinal curvilinear tendency, a cross-sectional vertically curvilinear elongation, and a laterally viewed circular or oval shape, with said symmetry being bilateral across vertical and horizontal top and bottom view planer axes, and across vertical lateral and end view planer axes but not across horizontal lateral and end view planer axes, and two said at least one elongated channels are elongated longitudinally and traverse laterally;
said main body shape being horizontally disc shaped overall with a longitudinal curvilinear tendency, a cross-sectional horizontally curvilinear elongation, and a laterally viewed flattened oval shape, with said symmetry being bilateral across vertical and horizontal top and bottom view planer axes, and across vertical lateral and end view planer axes but not across horizontal lateral and end view planer axes, and two said at least one elongated channels are elongated longitudinally and traverse laterally;
said main body shape being vertically egg shaped overall with an upward orientation, with said symmetry being multilateral across vertical and horizontal top and bottom view planer axes, and bilateral across vertical lateral and end view planer axes but not across horizontal lateral and end view planer axes, and all said at least one elongated channels are elongated vertically and traverse radially, and said central chamber is elongated in a vertical orientation.

7. The jig body of claim 1, further comprising:
Said jig body having a main body shape;
Said main body shape selected from the group consisting of the shape of a fish body, the shape of a flounder body, the shape of a ray body, the shape of a squid body, the shape of a crab body, the shape of a lobster body, the shape of a octopus body, the shape of an eel body, the shape of a worm body, the shape of a snake body, the shape of a crustation body, and the shape of an invertebrate body.

8. The jig body of claim 6, wherein said main body shape being vertically egg shaped overall with said symmetry being multilateral across vertical and horizontal top and bottom view planer axes, further comprises:
said at least one of said first attachment eye disposed centrally on said dorsal surface; and
at least one of said at least one second attachment eye for each elongated channel disposed on a dorsal radial edge.

9. The jig body of claim 1, further comprising:
at least one attachable weight cassette, each said attachable weight cassette having a shape complementary to a receiving surface on said jig body;
each said attachable weight cassette combinable with an additional said attachable weight cassette; and
each said attachable weight cassette attachable to and removable from said jig body when at least one said additional attachable weight cassette is already attached to said jig body.

10. A jig body having a main body shape, wherein:
said main body shape is selected from the group consisting of the shape of a fish body, the shape of a flounder body, the shape of a ray body, the shape of a squid body, the shape of a crab body, the shape of a lobster body, the shape of a octopus body, the shape of an eel body, the shape of a worm body, the shape of a snake body, the shape of a n amphibian body, the shape of a crustation body, the shape of a vertebrate body and the shape of an invertebrate body;
said jig body encasing an elongated central chamber, said elongated central chamber sized to removably constrain a chemiluminescent cartridge therewithin,
at least one elongated channel communicating a lateral external exterior surface with said chemiluminescent cartridge, and
a total number of attachment eyes for at least one less than one attachment eye for each said at least one elongated channel through which said chemiluminescent cartridge can be inserted to and removed from said elongated central chamber.

11. A jig made from the jig body of claim 1.

12. A method of manufacturing the jig body of claim 1, comprising the steps of:
molding said lead core of said jig body in a mold designed to produce said lead core in a size and weight appropriate for jigging at a specified depth and current; and
coating said lead core to form said coating layer.

13. A method of manufacturing the jig body of claim 12, wherein the step of molding said lead core of said jig body in a mold further comprises the steps of:
inserting a plug in a mold, said plug having a shape imposed into a cavity of said mold that is the solid equivalent of said central chamber and said elongated channel;
inserting first and second attachment eye forming means;
assembling said mold; and
introducing a molten lead metal into said cavity.

14. A method of using the jig body of claim 1, comprising the steps of:
making a jig; and
pressing an activatable chemiluminescence cartridge into said central chamber through one of said at least one elongated channels thereby causing said activatable chemiluminescence cartridge to flex and activate.

15. The jig body of claim 1, further comprising:
at least one light emitting channel leading from said central chamber to at least one of a lateral surface, a dorsal surface, a ventral surface, a leading end surface and a trailing end surface.
